(19) United States
(12) Patent Application Publication
(10) Pub. No.: US 2025/0003272 A1
(43) Pub. Date: Jan. 2, 2025

(54) APPARATUSES AND SYSTEMS FOR LIMITING THE RANGE OF ROTATION OF A SWINGOUT TAILGATE OF A VEHICLE WHEN OPENED AND RELATED METHODS

(71) Applicant: South East Manufacturing Inc., Wilson, NC (US)

(72) Inventors: Zachary Hall, Lucama, NC (US); Timothy Martin, New Bern, NC (US); Nicholas Martin, New Bern, NC (US)

(21) Appl. No.: 18/759,209

(22) Filed: Jun. 28, 2024

Related U.S. Application Data
(60) Provisional application No. 63/510,809, filed on Jun. 28, 2023.

(51) Int. Cl. E05D 5/06; E05D 7/04

(52) U.S. Cl. CPC E05D 5/062; E05D 7/04; E05Y 2900/546

(57) ABSTRACT

Apparatuses and systems for limiting the range of motion of an opened tailgate of a vehicle and related methods are provided herein. A tailgate limiter apparatus can be provided for securement to a tailgate for limiting the range of motion of a swingout tailgate on a vehicle. The tailgate limiter apparatus can include an elongated body having a first end and a second end. The elongated body can include a plurality of hinge connector acceptance apertures extends through the elongated body. Each of the hinge connector acceptance apertures is configured to selectively receive a hinge connector of a hydraulic hinge used on the tailgate of the vehicle to limit the radius of swing of the tailgate of the vehicle to different degrees of swing.

### RELATED APPLICATION

The present application and presently disclosed subject matter claims the benefit of U.S. Provisional Patent Application Ser. No. 63/510,809, filed Jun. 28, 2023, the disclosure of which is incorporated herein by reference in its entirety.

### TECHNICAL FIELD

The present subject matter relates to apparatuses and systems for limiting the range of motion of an opened tailgate of a vehicle and related methods. In particular, the present subject matter relates to tailgate limiter apparatuses that are securable to a side-opening tailgate of a vehicle that swing outward that limits the radius of swing of the tailgate to permit an adjustment of the range of motion of the tailgate when opened.

### BACKGROUND

Sports Utility Vehicles (“SUVs”) have gained tremendous popularity over the past several years and have quickly become one of the most common body types you will see on the road. A big reason why SUVs are so popular is due to versatility and cargo space. Smaller SUVs are great for commuters or small families that need a bit more room than a sedan or hatchback can provide. Many SUVs offer even more space inside the cabin, with a large range of sizes available, including compact and full-size mode. SUVs also tend to offer a wide range of drivetrain options. Front-wheel drive is common as an affordable and fuel-efficient option for drivers. All-wheel drive is a popular choice among SUV drivers in that it helps them handle the vehicle easier in slippery road conditions. Some SUVs offer rear-wheel drive. For drivers how enjoy outdoor activities, many SUVs offer four-wheel drive for enhanced performance.

Some SUVs, such as Jeeps® and the new Ford Broncos®, have been designed to be highly customizable with modular designs that permit companies to provide aftermarket parts and additional components that add features not offered on the respective vehicles by the manufacturer. For example, off-road modular SUV designs offer a user-friendly platform that can be stripped to its base structure so that alternate doors, fenders, and grille can be added in one afternoon. The following day, a whole new SUV can be reconfigured for another new adventure with a different body and roof setup. Such SUVs were designed and engineered from a clean slate to make off-road customization easy, quick, and attainable for all enthusiasts with a wide variety of interests and skill levels.

Some vehicles, such as a Ford Broncos®, have tailgates that have side hinges that permit the tailgates to swing outward. These swingout tailgates are connected to the frame of the vehicle by a hydraulic hinge that secures to the tailgate at a single location on the tailgate. Due the location of the single connection, the swingout tailgate swings out the same distance so that the range of motion of the tailgate is always the same. However, in some instances, an owner of the vehicle may need the tailgate to open wider or open less such that the degree of rotation of the swingout tailgate is more or less. For some such vehicles, the hydraulic hinge may have a limiting mechanism on it that can limit swingout tailgate to opening 90° while the tailgate swingout to over 110° when the mechanism is not engaged. Such a hydraulic hinge limiting mechanism does not always hold well and can possibly damage the piston rod of the hydraulic hinge. Further, depending on their needs, a user may want to have more dependable options of the range of rotation of the swingout tailgate.

As such, a need exists for devices, apparatuses, and/or systems that can limit the range of rotation of the swingout tailgate of sport utility vehicles to meet the needs of the owner or user of the vehicle.

### SUMMARY

The present subject matter relates to apparatuses and systems for limiting the range of motion of an opened tailgate of a vehicle and related methods. In particular, the present subject matter relates to tailgate limiter apparatuses that are securable to a side-opening, or swingout, tailgate of a vehicle that limits the radius of swing or range of rotation of the tailgate to permit an adjustment of the range of motion of the tailgate when opened. Methods related to the use and assembly of the apparatuses and systems for limiting the range of rotation of an opened tailgate of a vehicle disclosed herein are also provided.

Thus, it is an object of the presently disclosed subject matter to provide apparatuses and systems for limiting the range of motion of an opened tailgate of a vehicle as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A, 1B, and 1C illustrate perspective views of a rear of a vehicle having a swingout tailgate that is opened with FIGS. 1B and 1C illustrating an embodiment of a tailgate limiter apparatus according to present subject matter;

FIG. 2A illustrates an exterior perspective view of an embodiment of a swingout tailgate that faces an interior of a vehicle as used on the vehicles according to FIGS. 1A and 1B with a tailgate limiter apparatus that can be used to change the range of rotation of the tailgate according to the present subject matter;

FIG. 2B illustrates a perspective view of a portion of the embodiment of the swingout tailgate according to FIG. 2A as shown in area FIG. 2B in FIG. 2A according to the present subject matter;

FIG. 3A illustrates an interior perspective view of the embodiment of the swingout tailgate according to FIG. 2A;

FIG. 3B illustrates a perspective view of a portion of the embodiment of the swingout tailgate according to FIG. 3A as shown in area FIG. 3B in FIG. 3A according to the present subject matter;

FIG. 4A illustrates a side plan view of the embodiment of the swingout tailgate according to FIG. 2A;

FIG. 4B illustrates a cross-sectional view of the embodiment of the swingout tailgate according to FIG. 4A as taken along the line FIG. 4B-FIG. 4B in FIG. 4A according to the present subject matter;

FIG. 4C illustrates a perspective view of a portion of the embodiment of the swingout tailgate according to FIG. 4B as shown in area FIG. 4C in FIG. 4B according to the present subject matter;

FIG. 5A illustrates a perspective view of an embodiment of a tailgate limiter apparatus of a swingout tailgate according to the present subject matter;

FIG. 5B illustrates a top plan view of the embodiment of the tailgate limiter apparatus according to FIG. 5A;

FIG. 5C illustrates a side plan view of the embodiment of the tailgate limiter apparatus according to FIG. 5A;

FIG. 5D illustrates a vertical cross-sectional view of a portion of the embodiment of the tailgate limiter apparatus according to FIG. 5C as shown in area FIG. 5D in FIG. 5C according to the present subject matter;

FIG. 5E illustrates a vertical cross-sectional view of a portion of the embodiment of the tailgate limiter apparatus according to FIG. 5C as shown in area FIG. 5E in FIG. 5C according to the present subject matter;

FIG. 6A illustrates a top plan view of the embodiment of the tailgate limiter apparatus according to FIG. 5A;

FIG. 6B illustrates a vertical cross-sectional view of a portion of the embodiment of the tailgate limiter apparatus according to FIG. 6A as taken along the line FIG. 6B-FIG. 6B in FIG. 6A according to the present subject matter;

FIG. 6C illustrates a vertical cross-sectional view of a portion of the embodiment of the tailgate limiter apparatus according to FIG. 6B according to the present subject matter;

FIG. 7A illustrates a perspective view of an embodiment of a bracket of the tailgate limiter apparatus according to FIG. 2A;

FIG. 7B illustrates a top plan view and a side plan of the embodiment of the bracket of the tailgate limiter apparatus according to FIG. 7A;

FIG. 8A illustrates a perspective view of another embodiment of a tailgate limiter apparatus of a swingout tailgate according to the present subject matter;

FIG. 8B illustrates a side plan view and a bottom plan view of the embodiment of the tailgate limiter apparatus of a swingout tailgate according to FIG. 8A;

FIG. 9 illustrates a perspective view of another embodiment of a tailgate limiter apparatus of a swingout tailgate according to the present subject matter; and

FIG. 10A illustrates a bottom rear perspective view of a further embodiment of a tailgate limiter apparatus of a swingout tailgate according to the present subject matter; and

FIG. 10B illustrates a top front perspective view of the embodiment of a tailgate limiter apparatus according to FIG. 10A.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, top, bottom, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the phrase “radius of swing” or “range of rotation” are used interchangeably herein in relation to a tailgate.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

The present subject matter relates to apparatuses and systems for limiting the range of rotation of an opened tailgate of a vehicle, such as a Ford Bronco®. For example, a tailgate limiter apparatus can be provided that are securable to a side-opening tailgate of a vehicle that swing outward that limits the radius of swing of the tailgate to permit an adjustment of the range of motion of the tailgate when opened.

Thus, the present disclosure is related to tailgate limiter apparatuses and systems that can be secured to a bottom portion of a swingout tailgate that permits the hinge connector on the piston of the hydraulic hinge of the tailgate to be attached to the tailgate limiter apparatus at different locations to provide different degrees of rotation of the swingout tailgate when opened. For example, a tailgate limiter apparatus for securement to a tailgate for limiting the range of motion of a swingout tailgate on a vehicle can be provided. The tailgate limiter apparatus can comprise an elongated body comprising a first end and a second end and one or more securement apertures that extend through at least a portion of the elongated body to facilitate securement of the elongated body to a tailgate on a vehicle. The tailgate limiter apparatus can also comprise a plurality of hinge connector acceptance apertures that extend through the elongated body. Each of the hinge connector acceptance apertures is configured to selectively receive a hinge connector of a hydraulic hinge used on the tailgate of the vehicle and the hinge connector acceptance apertures being spaced apart to limit the radius of swing of the tailgate of the vehicle to different degrees of swing based on the position of the respective hinge connector acceptance aperture once the elongated body is attached to a tailgate of a vehicle.

In another embodiment, a tailgate limiter apparatus for securement to a tailgate for limiting the range of motion of a swingout tailgate on a vehicle can be provided that comprises an elongated body comprising a first end and a second end with a first end securement aperture that extends through at least a portion of the elongated body proximate to the first end and a second end securement aperture that extends through at least a portion of the elongated body proximate to the second end. The tailgate limiter apparatus can also comprise a plurality of hinge connector acceptance apertures that extend through the elongated body. Each of the hinge connector acceptance apertures is configured to receive a hinge connector of a hydraulic hinge used on the tailgate of the vehicle and the hinge connector acceptance apertures being spaced apart to limit the radius of swing of the tailgate of the vehicle to different degrees of swing based on the position of the respective hinge connector acceptance aperture. Further, the tailgate limiter apparatus can comprise one or more fasteners configured for insertion into at least one of the first and second end securement apertures and engaging securement holes in the tailgate of the vehicle.

In another embodiment, a tailgate limiter apparatus for securement to tailgate for limiting the range of rotation of a swingout tailgate on a vehicles can be provided. The tailgate limiter apparatus can comprise an elongated body comprising a top surface, a bottom surface, a first side that extends between the top surface and the bottom surface, a second side opposite the first side that extends between the top surface and the bottom surface, a first end and a second end. The elongated body of tailgate limiter apparatus can also comprise a first end securement aperture that extends through at least a portion of the elongated body at the first end. The first end securement aperture can be configured for alignment with a mid-door securement hole in a tailgate of a vehicle. The elongated body of tailgate limiter apparatus can also comprise a second end securement aperture that extends through at least a portion of the elongated body at the second end. The second end securement aperture can be configured for alignment with a distal end door securement hole in the tailgate of the vehicle. Further, the elongated body of tailgate limiter apparatus can comprise a plurality of hinge connector acceptance apertures that extend through at least the bottom surface of the elongated body between the first securement aperture and the second securement aperture. Each of the hinge connector acceptance apertures can be configured to receive a hinge connector of a hydraulic hinge used on the tailgate of the vehicle. The hinge connector can comprise any conventional hinge attachment mechanism, for example, a clevis assembly, a screw insert, a nut and bolt assembly, or the like. The hinge connector acceptance apertures can be spaced apart to limit the radius of swing of the tailgate of the vehicle to different degrees of rotation based on the position of the respective hinge connector acceptance aperture.

Additionally, the tailgate limiter apparatus can comprise an elongated bolt having a head on a first end and being threaded on at least a second end. In use, the elongated bolt can be inserted through the second end securement aperture and can engage the distal end door securement hole in the tailgate of the vehicle. Further, the tailgate limiter apparatus can comprise a pinch bracket having a bracket aperture for receiving the second end of the elongated body.

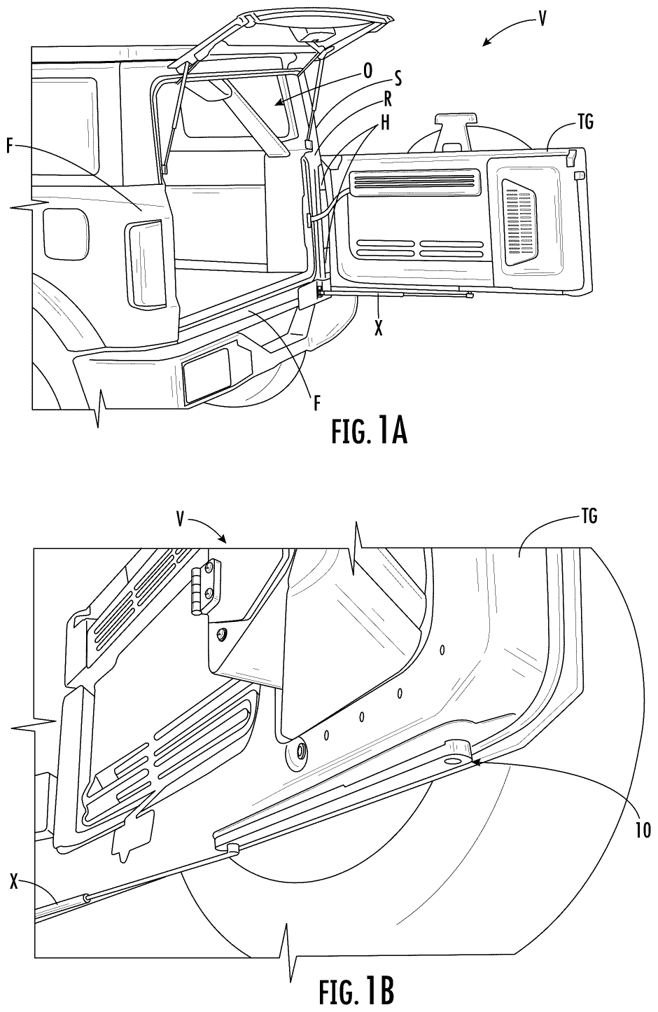

FIGS. 1A-1C shows images of an SUV V, in particular, a Ford Broncos®, with a swingout tailgate TG. The tailgate TG is attached by hinges H on a right side S of the tailgate TG to the frame F of the vehicle V that permits the tailgate TG to open in a rotational manner about an axis that runs through the hinges H. To limit the range of rotation, a hydraulic hinge X is secured to the frame F below the back opening O of the vehicle V on a cylinder side of the hydraulic hinge X and to a bottom of portion of the tailgate TG on the piston side of the hydraulic hinge X. In particular, the piston arm of the hydraulic hinge X can have a hinge connector or some other attachment device on its exposed end that is secured to the bottom of the tailgate TG. Additionally, a cylinder of the hydraulic hinge X can have a hinge connector or some other attachment device on its exposed end that is secured to the frame F below the back opening O of the vehicle V. In this manner, through the use of the hydraulic hinge X, the tailgate TG can be opened in a controlled manner and its range of rotation can be limited.

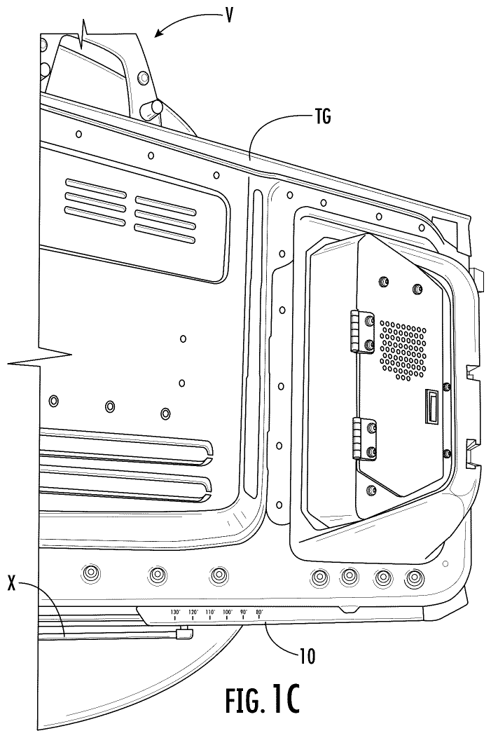

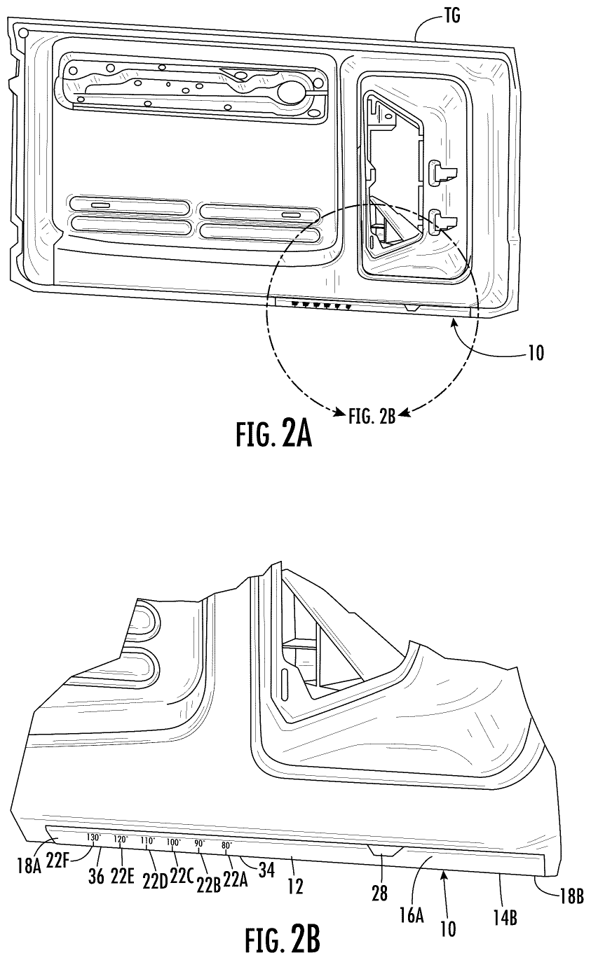

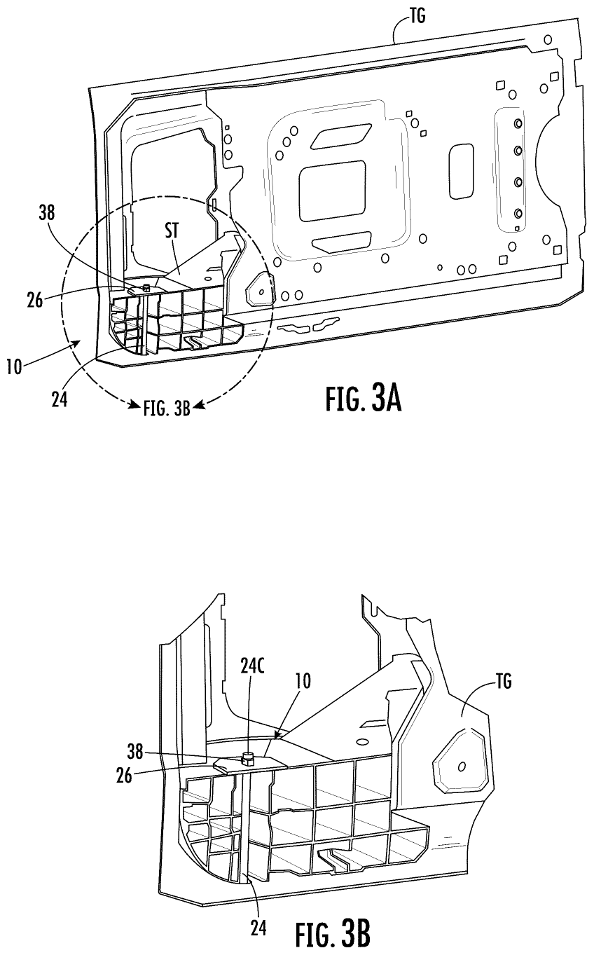

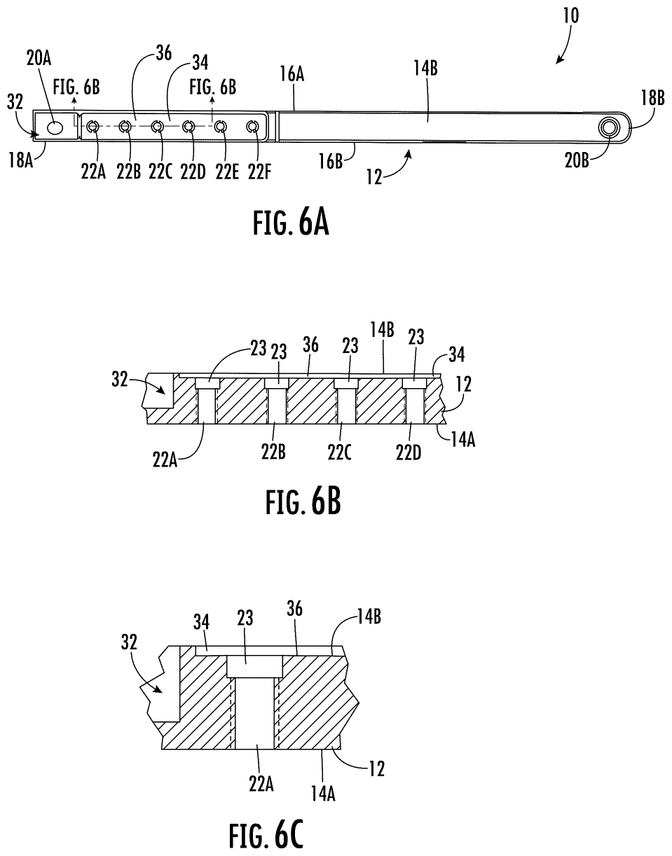

The tailgate TG of the vehicle V only provides one attachment location for the hinge connector or other attachment device of the piston arm of the hydraulic hinge X so that the tailgate TG of the vehicle V opens to the same degree of rotation every time. To increase the available range of rotation of the swingout tailgate TG, a tailgate limiter apparatus, generally 10, can be added to the swingout tailgate TG as shown in FIGS. 1B and 1C. Referring to FIGS. 2A-7B, the present disclosure provides a tailgate limiter apparatus, generally designated 10, shown in FIGS. 2A, 2B and 4C that can be secure to the bottom of the tailgate TG of the vehicle V and permits the tailgate TG of the vehicle V to be opened to different degrees of rotation of a range of degrees of rotation to provide different levels of openness of tailgate TG. Thus, the tailgate limiter apparatus 10 can be secured to the tailgate TG as shown in FIGS. 2A-3A to limit the range of rotation of a swingout tailgate TG on the vehicle V.

Referring to FIGS. 2A-6C, the tailgate limiter apparatus 10 can comprise an elongated body 12 comprising a first end 18A and a second end 18B and one or more securement apertures 20A, 20B that extend through at least a portion of the elongated body 12 to facilitate securement of the elongated body 12 to the tailgate TG on the vehicle V. The tailgate limiter apparatus 10 can also comprise a plurality of hinge connector acceptance apertures 22A, 22B, 22C, 22D, 22E, 22F 22A, 22B, 22C, 22D, 22E, 22F that extend through the elongated body 12. Each of the hinge connector acceptance apertures 22A, 22B, 22C, 22D, 22E, 22F is configured to selectively receive a hinge connector of a hydraulic hinge X used on the tailgate TG of the vehicle V and the hinge connector acceptance apertures 22A, 22B, 22C, 22D, 22E, 22F being spaced apart to limit the radius of swing of the tailgate TG of the vehicle V to different degrees of swing based on the position of the respective hinge connector acceptance aperture 22A, 22B, 22C, 22D, 22E, 22F once the elongated body 12 is attached to a tailgate TG of a vehicle V.

In particular, in the embodiment shown, the tailgate limiter apparatus 10 can comprise a top surface 14A and a bottom surface 14B that can reside between the first end 18A and the second end 18B. The tailgate limiter apparatus 10 can also comprise a first side 16A and a second side 16B opposite the first side 16A that extend between the first end 18A and the second end 18B. The first side 16A and the second side 16B can also extend between the top surface 14A and the bottom surface 14B.

The elongated body 12 of tailgate limiter apparatus 10 can be secured to the tailgate TG of the vehicle V such that at least a portion of the top surface 14A of the elongated body 12 can abut against an inner lip of the bottom of the tailgate TG of the vehicle V. In some embodiments, the one or more securement apertures can align with one or more door securement holes in the bottom of the tailgate TG, such as a mid-door securement hole MD, a distal end door securement hole DD, and/or a medium door securement hole SD that is between the mid-door securement hole MD and distal end door securement hole DD as shown in FIG. 4C. Fasteners 24, 25, such as screws, rivets, bolts, or the like, can be used to secure the tailgate limiter apparatus 10 via the one or more securement apertures and the mid-door securement hole MD, the distal end door securement hole DD, and/or the medium door securement hole SD.

For example, in some embodiments, the one or more securement apertures of the elongated body 12 of the tailgate limiter apparatus 10 can comprise a first end securement aperture 20A and a second end securement aperture 20B. The first end securement aperture 20A can extend through at least a portion of the elongated body 12 at the first end 18A. The first end securement aperture 20A can be configured for alignment with the mid-door securement hole MD in the tailgate TG of the vehicle V. For example, in some embodiments, the mid-door securement hole MD in the tailgate TG of the vehicle V can be the original securement aperture on the tailgate TG for receiving and holding the hinge connector, or other attachment device, on the end of the piston for the hydraulic hinge X. The hinge connector can be rotatable about the end of the piston to permit the changing of the hinge connector's orientation relative to the piston. The second end securement aperture 20B of the elongated body 12 of tailgate limiter apparatus 10 can extend through at least a portion of the elongated body 12 at the second end 18B. The second end securement aperture 20B can be configured for alignment with the distal end door securement hole DD in the tailgate TG of the vehicle V. In some embodiments, the second end securement aperture 20B can be configured for alignment with the medium door securement hole SD in the tailgate TG of the vehicle V. In some embodiments, the distal end door securement hole DD in the tailgate TG can be a pre-made aperture in the tailgate TG.

In the embodiment shown in FIGS. 4A-6C, the elongated body 12 of tailgate limiter apparatus 10 can have the plurality of hinge connector acceptance apertures 22A, 22B, 22C, 22D, 22E, 22F extend through at least the bottom surface 14B of the elongated body 12 between the first securement aperture 20A and the second securement aperture 20B. Each of the hinge connector acceptance apertures 22A, 22B, 22C, 22D, 22E, 22F can be configured to receive the hinge connector of the hydraulic hinge X used on the tailgate TG of the vehicle V. As above, the hinge connector acceptance apertures 22A, 22B, 22C, 22D, 22E, 22F can be spaced apart to limit the radius of swing of the tailgate TG of the vehicle V to different degrees of rotation based on the position of the respective hinge connector acceptance aperture 22A, 22B, 22C, 22D, 22E, 22F.

Further, a fastener 24 of the tailgate limiter apparatus 10 can comprise an elongated bolt 24 having a head 24A on a first end 24B and being threaded on at least a second end 24C. In use, the elongated bolt 24 can be inserted through the second end securement aperture 20A and can engage the distal end door securement hole DD in the tailgate TG of the vehicle V. Further, the tailgate limiter apparatus 10 can comprise a pinch bracket 26 having a bracket aperture 26A for receiving the second end 24C of the elongated body 24.

For installation on some vehicles V, for example, the swingout tailgate TG of the vehicle V can be opened, and the hinge connector of the hydraulic hinge X used on the tailgate TG of the vehicle V can be disengaged from the tailgate TG. The elongated body 12 of tailgate limiter apparatus 10 can be positioned along the inner lip of the bottom of the swingout tailgate TG so that the first end securement aperture 20A aligns with a mid-door securement hole MD in the tailgate TG and the second end securement aperture 20B aligns with a distal end door securement hole DD in the tailgate TG. The first end 18A of the elongated body 12 can be secure to the swingout tailgate TG by engaging a fastener 25, such as a properly sized screw or bolt, in the first end securement aperture 20A and a mid-door securement hole MD in the tailgate TG. The elongated bolt 24 can be inserted through the second end securement aperture 20B and the distal end door securement hole DD in the tailgate TG such that the threaded second end 24C extends outward from a structure ST of the swingout tailgate TG. The pinch bracket 26 can be placed over the second end 24C of the elongated bolt 24 with the second end 24C passing through the bracket aperture 26A so that the pinch bracket 26 resides against the structure ST of the swingout tailgate TG. In some embodiments, for example, a nut 38 can be provided that can engage the second end 24C of the elongated bolt 24 to press the pinch bracket 26 against the structure ST of the swingout tailgate TG and tightly hold the tailgate limiter apparatus 10 in place. In some embodiments, the pinch bracket 26 can have an integral nut attached or the bracket aperture 26A can be threaded to engage the second end 24C of the elongated bolt 24 to secure the tailgate limiter apparatus 10. The hinge connector of the hydraulic hinge X can then be secured in one of the hinge connector acceptance apertures 22A, 22B, 22C, 22D, 22E, as desired.

For example, in some embodiments, the hinge connector acceptance apertures 22A, 22B, 22C, 22D, 22E, 22F can be spaced apart from each other along the elongated body 12 such that when secured to the tailgate TG of the vehicle V, the plurality of hinge connector acceptance apertures 22A, 22B, 22C, 22D, 22E, 22F can limit the radius of swing of the tailgate TG between about 80° and about 135°. The first side 16A of the elongated body 12 can be marked with indicia that indicates the angle of swing or rotation that each of the plurality of hinge connector acceptance apertures 22A, 22B, 22C, 22D, 22E, 22F provides. For example, a first hinge connector acceptance aperture 22A of the plurality of hinge connector acceptance apertures 22A, 22B, 22C, 22D, 22E, 22F can be located on the elongated body 12 to set the radius of swing of the tailgate TG at about 80°. A second hinge connector acceptance aperture 22B of the plurality of hinge connector acceptance apertures 22A, 22B, 22C, 22D, 22E, 22F can be located on the elongated body 12 to set the radius of swing of the tailgate TG at about 90°. A third hinge connector acceptance aperture 22C of the plurality of hinge connector acceptance apertures 22A, 22B, 22C, 22D, 22E, 22F can be located on the elongated body 12 to set the radius of swing of the tailgate TG at about 100°. A fourth hinge connector acceptance aperture 22D of the plurality of hinge connector acceptance apertures 22A, 22B, 22C, 22D, 22E, 22F can be located on the elongated body 12 to set the radius of swing of the tailgate TG at about 110°. A fifth hinge connector acceptance aperture 22E of the plurality of hinge connector acceptance apertures 22A, 22B, 22C, 22D, 22E, 22F can be located on the elongated body 12 to set the radius of swing of the tailgate TG at about 120°. A sixth hinge connector acceptance aperture 22F of the plurality of hinge connector acceptance apertures 22A, 22B, 22C, 22D, 22E, 22F can be located on the elongated body 12 to set the radius of swing of the tailgate TG at about 135°.

In some embodiments that have an extended elongated body 12 such that engage the distal end door securement hole DD, as shown in FIGS. 4B and 4C, the elongated body 12 has a slot 28 on the top surface 14A positioned between the second end securement aperture 20B and the plurality of hinge connector acceptance apertures 22A, 22B, 22C, 22D, 22E, 22F configured for providing space to receive a bolt head extending from the bottom of the tailgate TG when the elongated body 12 is installed. In some embodiments, the bolt head, for example, can extend from the medium door securement hole SD. In some embodiment, the slot 28 in the elongated body 12 can extend through the first and second sides 16A, 16B of the elongated body 12. The slot 12 can comprise a floor 28A and opposing walls 28B, 28C that extend up from the floor 28A of the slot 28 at an angle extending away from each other. For example, the opposing walls 28B, 28C can be slanted at 135° angles from the floor 28A. Additionally, in some embodiments, the elongated body 12 can have an accommodation indention 30 on the top surface 14A between the slot 28 and the second end securement aperture 20B, the accommodation indention 30 can be configured to accommodate a plug in the tailgate of the vehicle.

In some embodiments, the first end 18A of the elongated body 12 can have a securement indention 32 on the bottom surface 14B of the elongated body 12 between the first and second sides 16A, 16B. The securement indention 32 can extend through the first end 18A. The first end securement aperture 20A can reside in the first end 18A at the securement indention 32 extending through the first end 18A of the elongated body 12 at the securement indention 32.

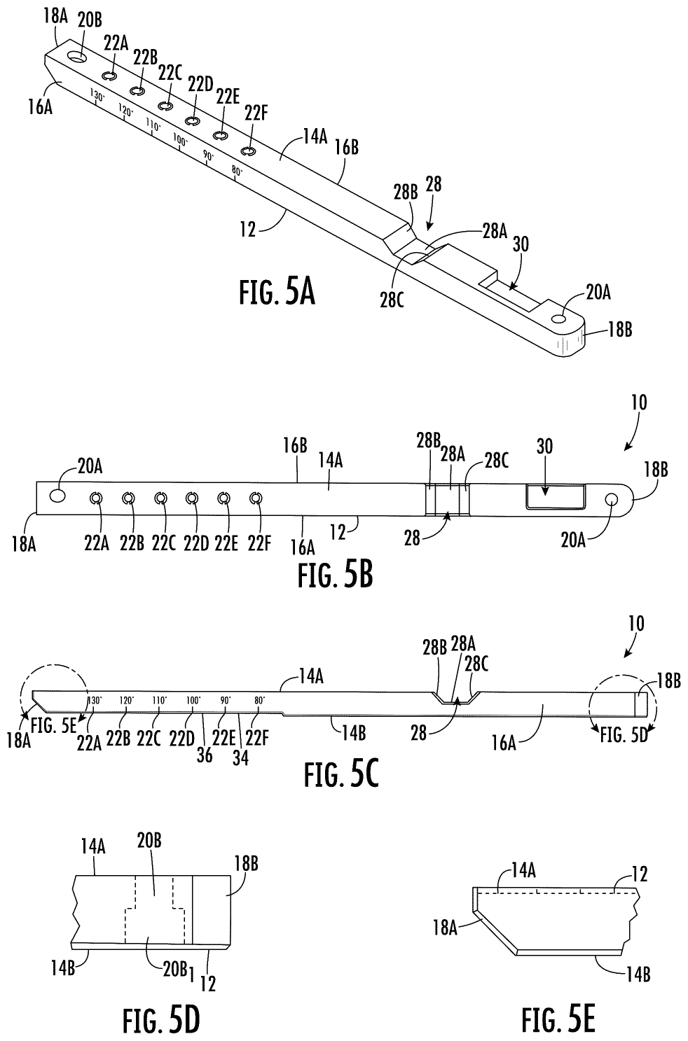

In some embodiments, the bottom surface 14B of the elongated body 12 can comprise a hinge attachment indention 34 that can extend a length of a hinge attachment area 36 in which the plurality of hinge connector acceptance apertures 22A, 22B, 22C, 22D, 22E, 22F resides. In such embodiments as shown in FIGS. 6B and 6C, each of the plurality of hinge connector acceptance apertures 22A, 22B, 22C, 22D, 22E, 22F can comprise a counterbore 23 in the bottom surface 14B of the elongated body 12 in the hinge attachment indention 34. The counterbore 23 in the bottom surface 14B can be configured to receive a portion of a hinge connector of a hinge X. In some embodiments, the hinge attachment indention 34 can have a depth of between about 0.0610 inches and about 0.0640 inches.

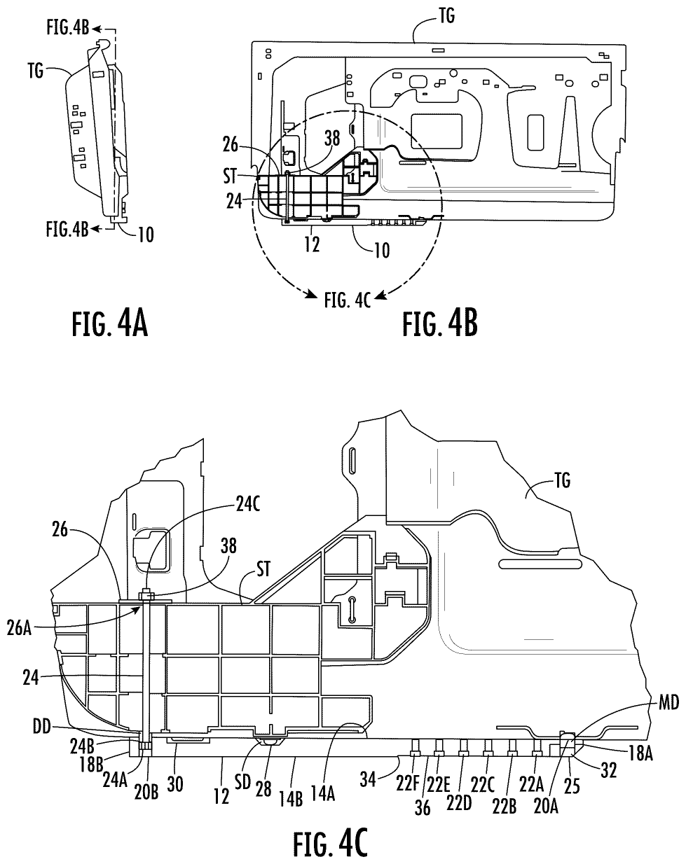

In some embodiments as shown in FIG. 5D, the second end securement aperture 20B can comprise a counterbore 20B₁ in the bottom surface 14B of the elongated body 12 for receiving the head 24A of the elongated bolt 24. As shown in FIGS. 3A, 3B, and 4C, the elongated bolt 24 can comprise a length that permits the elongated bolt 24 to be inserted through the second end securement aperture 20B into the tailgate TG of the vehicle V and through the structure ST in the tailgate TG of the vehicle V with threaded second end 24C of the elongated bolt 24 extending outward from the structure ST of the swingout tailgate TG. As described above, the threaded second end 24C of the elongated bolt 24 can be placed through the pinch bracket 26 such that the pinch bracket 26 resides against the structure ST in the tailgate TG and the nut 38 can be screwed onto the threaded second end 24C of the elongated bolt 24 to abut the pinch bracket 26. In this manner, the second end 18B of the tailgate limiter apparatus 10 can be held firmly against the bottom of the tailgate TG.

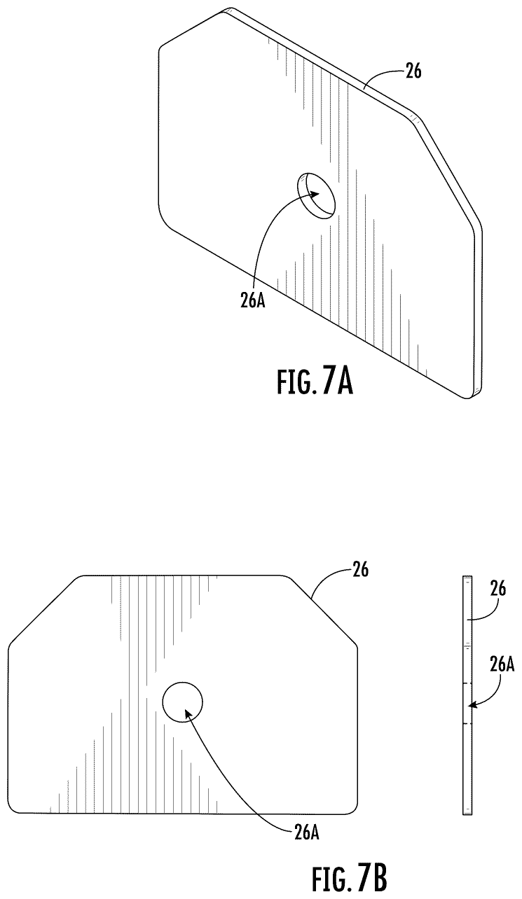

Referring to FIGS. 8A and 8B, another embodiment of a tailgate limiter apparatus, generally 40, is provided that is securable to a swingout tailgate for limiting the range of motion of the swingout tailgate on a vehicle. The tailgate limiter apparatus 40 can comprise an elongated body 42 that comprises a first end 48A and a second end 48B with a first end securement aperture 50A that extends through at least a portion of the elongated body 42 proximate to the first end 48A and a second end securement aperture 50B that extends through at least a portion of the elongated body 42 proximate to the second end 48B. The elongate body 42 can have a length L₂. The length L₂ of the elongated body 42 can vary depending on the respective securement holes MD, SD, DD that are used. For example, when the medium door securement hole SD is used with the mid-door securement hole MD, then the length L₂ of an elongated body 42 can be a shorter distance. When the distal end door securement hole DD is used with the mid-door securement hole MD, then the length L₂ of an elongated body 42 can be a longer distance.

Referring to FIGS. 1A-1C, 4C, 8A, and 8B for reference, the tailgate limiter 40 can comprise a plurality of hinge connector acceptance apertures 42A, 42B, 42C that extend through the elongated body 42. Each of the hinge connector acceptance apertures 42A, 42B, 42C can be configured to receive the hinge connector of the hydraulic hinge used on the tailgate TG of the vehicle V as shown in FIGS. 1A and 1B. Even though the elongated body 42 looks different, the hinge connector acceptance apertures 42A, 42B, 42C are spaced apart to limit the radius of swing of the tailgate TG of the vehicle V to different degrees of swing based on the position of the respective hinge connector acceptance aperture 42A, 42B, 42C. The number of connector acceptance aperture 42A, 42B, 42C can vary depending on the number of optional settings that are desired. The hinge connector acceptance apertures 42A, 42B, 42C can be spaced apart at the same or varying distances. For example, a space HD₁ between the hinge connector acceptance aperture 42A and the hinge connector acceptance aperture 42B can be the same as or different from a space HD₂ between the hinge connector acceptance aperture 42B and the hinge connector acceptance aperture 42C. As above, one or more fasteners can be configured for insertion into at least one of the first and second end securement apertures 50A, 50B to engage securement holes MD, SD, DD in the tailgate TG of the vehicle V. The first end securement aperture 50A and the second end securement aperture 50B can be separated by a distance AD₂ that can generally correspond to a distance between the respective securement holes MD, SD, DD in the tailgate TG that are intended to be used by the tailgate limiter apparatus 40 for securement to the tailgate TG of the vehicle V. The distance AD₂ between the first and second end securement apertures 50A, 50B can be measured, for instance, between centerlines of the first and second end securement apertures 50A, 50B. The distance AD₂ between the first and second end securement apertures 50A, 50B can vary depending on the respective securement holes MD, SD, DD used. For example, when the medium door securement hole SD is used with the mid-door securement hole MD, then the distance AD₂ between the first and second end securement apertures 50A, 50B can be a shorter distance. When the distal end door securement hole DD is used with the mid-door securement hole MD, then the distance AD₂ between the first and second end securement apertures 50A, 50B can be a longer distance.

In the embodiment shown in FIGS. 8A and 8B, the elongated body 42 of the tailgate limiter apparatus 40 can further comprise a top surface 44A that resides between the first end 48A and the second end 48B. Additionally, the elongated body 42 of the tailgate limiter apparatus 40 can further comprise a bottom surface 44B opposite the top surface 44A that extends between the first end 48A and the second end 48B. The elongated body 42 of the tailgate limiter apparatus 40 can also comprise a first side 46A that also extends between the first end 48A and the second end 48B and a second side 46B opposite the first side 46A that extends between the first end 48A and the second end 48B. Additionally, the first and second sides 46A, 46B of the elongated body 42 can extend between the top surface 44A and the bottom surface 44B.

The elongated body 42 can be thinner than the elongated body 22 shown in FIGS. 5A-5B such that the elongated body 42 can have a thickness T₂ that form the first and second sides 46A, 46B that is less than the width W₂ of the elongated body 42. The elongated body 42 can have a hinge connector section 52 that is positioned lower than fastener sections 54A, 54B at the respective first end 48A and the second end 48B when the tailgate limiter apparatus 40 is secured to an underside of the tailgate of the vehicle. For example, in some embodiments, the fastener sections 54A, 54B at the respective first end 48A and the second end 48B can reside in a first plane AP₁ and the hinge connector section 52 can reside in a second plane AP₂ that is off set from each other. The different positioning of the fastener sections 54A, 54B at the respective first end 48A and the second end 48B and the hinge connector section 52 provides a distance H_{S} between a top surface of the fastener sections 54A, 54B and the top surface 44A of the hinge connector section 52 that creates space between the bottom of the tailgate to which the tailgate limiter apparatus 40 is attached. For example, the first plane AP₁ in which the fastener sections 54A, 54B at the respective first end 48A and the second end 48B reside is above the second plane AP₂ in which the hinge connector section 52 resides when the tailgate limiter apparatus 40 is attached to the tailgate of the vehicle with the top surface of the fastener sections 54A, 54B at the respective first end 48A and the second end 48B residing against the bottom of the tailgate. The distance H_{S} creates a space between the bottom of the tailgate and the top surface 44A of the hinge connector section 52. In this manner, the distance H_{S} can provide space for attachment of the hinge connector of the hydraulic hinge and/or provide clearance for any plugs, fastener heads, or other protrusions extending form the bottom of the tailgate. The elongated body 42 of the tailgate limiter apparatus 40 can have an overall height H_{L} that allows for the distance H_{S} to create the space between the bottom of the tailgate and the top surface 44A of the hinge connector section 52 but permits the tailgate limiter apparatus 40 to not interfere with the closing of the tailgate of the vehicle.

The elongated body 42 can have transition sections 56A, 56B that extends between the fastener sections 54A, 54B and the hinge connector section 52. The transition sections 56A, 56B can comprise different shapes. For example, in some embodiments, the transition sections 56A, 56B can be curved (not shown). In some embodiments, the transition sections 56A, 56B can be more linear as shown in FIGS. 8A and 8B. In some embodiments, the transition sections 56A, 56B can extend about perpendicular to both the fastener sections 54A, 54B and the hinge connector section 52 such that the transition sections 56A, 56B can be about perpendicular to both the fastener sections 54A, 54B and the hinge connector section 52. In some embodiments, the transition sections 56A, 56B can extend at angles from the fastener sections 54A, 54B down to the hinge connector section 52 as shown in FIGS. 8A and 8B. For example, the transition sections 56A, 56B can extend downward at an angle α from the fastener sections 54A, 54B and upward from the hinge connector section 52 at an angle β. The angle α can be an obtuse angle and the angle β can be an obtuse angle. In some embodiments, the angle α and angle β can be the same angle. In such embodiments, the lengths of the transition sections 56A, 56B can be determined by the desired distance H_{S} between the bottom of the tailgate and the top surface 44A of the hinge connector section 52 and the angle α from which the transition sections 56A, 56B extend from the fastener sections 54A, 54B.

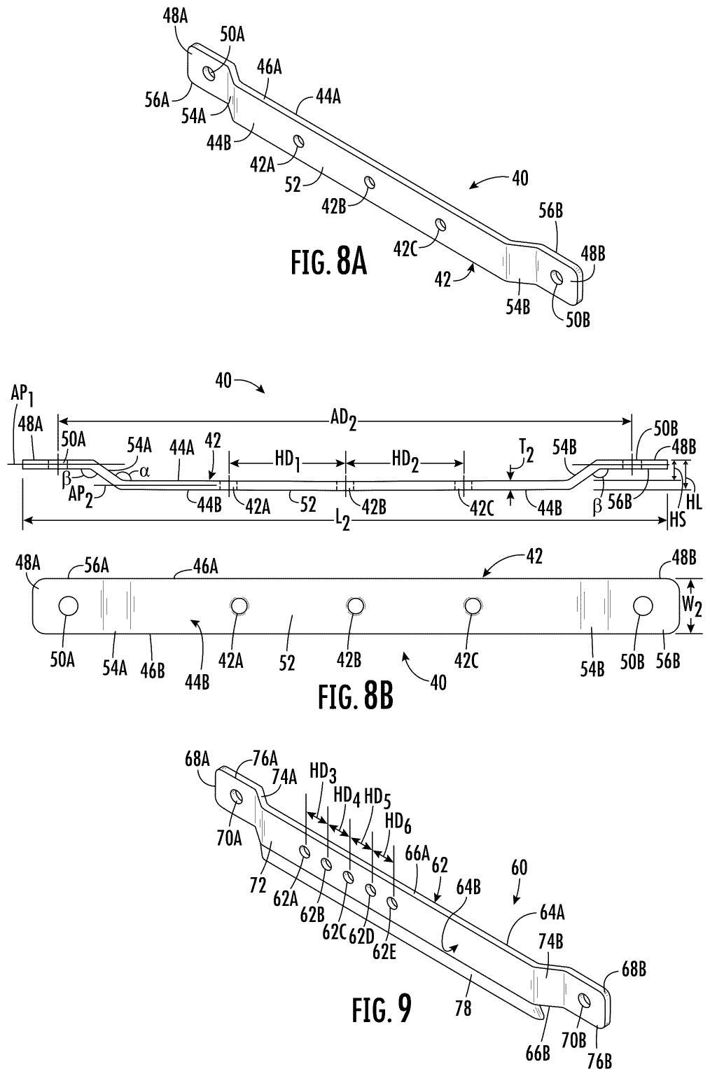

Referring to FIG. 9, another embodiment of a tailgate limiter apparatus, generally 60, is provided that is securable to a swingout tailgate for limiting the range of motion of the swingout tailgate on a vehicle. The tailgate limiter apparatus 60 is similar in structure and operation to the tailgate limiter apparatus 40 shown in FIGS. 8A and 8B. The tailgate limiter apparatus 60 can comprise an elongated body 62 that comprises a first end 68A and a second end 68B with a first end securement aperture 70A that extends through at least a portion of the elongated body 62 proximate to the first end 68A and a second end securement aperture 70B that extends through at least a portion of the elongated body 62 proximate to the second end 68B. As above, one or more fasteners can be configured for insertion into at least one of the first and second end securement apertures 70A, 70B to engage securement holes in the tailgate TG of the vehicle V. As shown in FIG. 9, the first and second end securement apertures 70A, 70B can be elongated to form more of a slot to allow for adjustability as well as variances in location of securement holes in bottom of the tailgate. As above, the elongate body 62 can have varying lengths for the reasons given above.

As shown in FIG. 9, the tailgate limiter 60 can comprise a plurality of hinge connector acceptance apertures 62A, 62B, 62C, 62D, 62E that extend through the elongated body 62. Each of the hinge connector acceptance apertures 62A, 62B, 62C, 62D, 62E can be configured to receive the hinge connector of the hydraulic hinge used on a tailgate of a vehicle V and are spaced apart to limit the radius of swing of the tailgate of the vehicle to different degrees of swing based on the position of the respective hinge connector acceptance aperture 62A, 62B, 62C, 62D, 62E. The number of connector acceptance aperture 62A, 62B, 62C, 62D, 62E can vary as discussed above and can be spaced apart at the same or varying distances. For example, the hinge connector acceptance apertures 62A, 62B, 62C, 62D, 62E can be spaced at distances HD₃, HD₄, HD₅, HD₆ therebetween.

The elongated body 62 of the tailgate limiter apparatus 60 illustrated in FIG. 9 can further comprise a top surface 64A that resides between the first end 68A and the second end 68B. Additionally, the elongated body 62 of the tailgate limiter apparatus 40 can further comprise a bottom surface 64B opposite the top surface 64A that resides between the first end 68A and the second end 68B. The elongated body 62 of the tailgate limiter apparatus 60 can also comprise a first side 66A that also extends between the first end 68A and the second end 68B and a second side 66B opposite the first side 66A that extends between the first end 68A and the second end 68B. Additionally, the first and second sides 66A, 66B of the elongated body 62 can extend between the top surface 64A and the bottom surface 64B. As with the elongated body 42 in FIGS. 8A and 8B, the elongated body 62 shown in FIG. 9 can have transition sections 76A, 76B that extends between the fastener sections 74A, 74B and the hinge connector section 72. The transition sections 76A, 76B can comprise different shapes as desired. As shown in FIG. 9, in some embodiments, the transition sections 76A, 76B can extend at angles from the fastener sections 74A, 74B down to the hinge connector section 72.

Unlike the elongated body 42 in FIG. 8, the embodiment of the elongated body 62 shown in FIG. 9 has a slanted guard 78 that extends from the second side 66B of the hinge connector section 72 of the elongated body 62. The slanted guard 78 can add a stiffness to the elongated body 62 that can be facilitated by an angle of the slant. When secured to a bottom of a tailgate, the slanted guard 78 can extend upward from the hinge connector section 72 toward an outer rear of the tailgate or toward the interior of the vehicle. The slanted guard 78 can also provide extra cover where the hinge connector connects to the tailgate limiter apparatus 60.

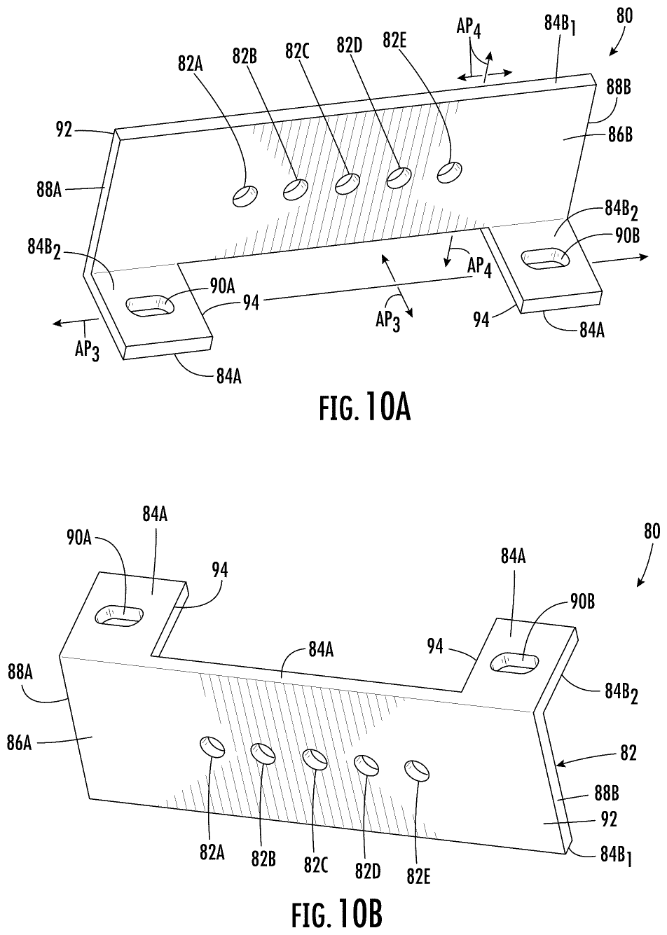

Referring to FIGS. 10A and 10B, another embodiment of a tailgate limiter apparatus, generally 80, is provided that is securable to a swingout tailgate for limiting the range of motion of the swingout tailgate on a vehicle. The tailgate limiter apparatus 80 can comprise an elongated body 82 that comprises a first end 88A and a second end 88B with a first end securement aperture 90A that extends through at least a portion of the elongated body 82 proximate to the first end 88A and a second end securement aperture 90B that extends through at least a portion of the elongated body 82 proximate to the second end 88B. As above, one or more fasteners can be configured for insertion into at least one of the first and second end securement apertures 90A, 90B to engage securement holes in the tailgate of the vehicle. In some embodiments as shown, the first and second end securement apertures 90A, 90B can be elongated to form more of a slot to allow for adjustability as well as variances in location of securement holes in the bottom of the tailgate. As above, the elongate body 82 can have varying lengths for the reasons given above. For example, in some embodiments, the length of the elongated body 82 can vary depending on the respective securement holes MD, SD, DD in the tailgate TG as shown in FIG. 4C that are used to secure the elongated body 82 of the tailgate limiter apparatus 80 to the tailgate TG of the vehicle. The tailgate limiter 80 can also comprise a plurality of hinge connector acceptance apertures 82A, 82B, 82C, 82D, 82E that extend through the elongated body 82. Each of the hinge connector acceptance apertures 82A, 82B, 82C, 82D, 82E can be configured to receive the hinge connector of the hydraulic hinge used on the tailgate TG of the vehicle V. As shown in FIGS. 10A and 10B, the elongated body 82 of the tailgate limiter apparatus 80 can also comprise a first side 86A that extends between the first end 88A and the second end 88B and a second side 86B opposite the first side 86A that extends between the first end 88A and the second end 88B. In this embodiment, the plurality of hinge connector acceptance apertures 82A, 82B, 82C, 82D, 82E extend through first side 86A and second side 86B of the elongated body 82 of the tailgate limiter apparatus 80.

In the embodiment shown in FIGS. 10A and 10B, the elongated body 82 of the tailgate limiter apparatus 80 can further comprise a top surface 84A that resides between the first end 88A and the second end 88B. Additionally, the elongated body 82 of the tailgate limiter apparatus 80 can further comprise a bottom surface 84B opposite the top surface 84A that resides between the first end 88A and the second end 48B. In particular, in some embodiments, the bottom surface 84B can comprise a first bottom surface 84B₁ and a second bottom surface 84B₂. Additionally, the first and second sides 86A, 86B of the elongated body 82 can extend between the top surface 84A and the bottom surface 84B.

The elongated body 82 can have a hinge connector section 92 and one or more fastener sections 94. For example, in some embodiments, a single fastener section 94 can extend at some portion between the first end 88A and the second end 88B with one or more securement apertures therein to secure the elongate body 82 to the bottom of the tailgate of a vehicle. As shown, the first end securement aperture 90A that extend through the fastener section 94 proximate to the first end 88A and a second end securement aperture 90B that extends through the fastener section 94 proximate to the second end 88B. In the embodiment shown, the hinge connector section 92 can be positioned transverse to fastener sections 94. For example, in some embodiments as shown, the fastener sections 94 at the respective first end 88A and the second end 88B can reside in a first plane AP₃ and the hinge connector section 92 can reside in a second plane AP₄ that is transverse, and more particularly, about perpendicular, to the first plane AP₃. In some embodiments where two or more fastener sections 94 are provided, the different positioning of the fastener sections 94 at the respective first end 88A and the second end 88B can provide space under the tailgate to provide clearance for any plugs, fastener heads, or other protrusions extending form the bottom of the tailgate.

In operation, the tailgate limiter apparatus 80 is attached to the tailgate of the vehicle with the fastener sections 94 at the respective first end 88A and the second end 88B and the top surface 84B of elongated body 82 residing against the bottom of the tailgate. The hinge connector section 92 extends downward transverse to the fastener sections 94 so that the hinge connector acceptance apertures 82A, 82B, 82C, 82D, 82E that extend through first side 86A and second side 86B of the elongated body 82 are transverse to the bottom of the tailgate. The hinge connector of the hydraulic hinge used on the tailgate of the vehicle can then be connected to a specific hinge connector acceptance apertures 82A, 82B, 82C, 82D, 82E that provides the desired range of rotation of the swingout tailgate on the vehicle.

Thus, in addition to a tailgate limiter apparatus as described above, a system for adjusting a range of rotation of a swingout tailgate of a vehicle is provided. The system can include the tailgate limiter apparatus with the elongated body as described above and the hydraulic hinge X that is secured to the frame of the vehicle. In some embodiments, the system can include the hinge attachment device that is connected to the frame of the vehicle.

Further, as described above, methods of assembly and use of the tailgate limiter apparatus are provided as described above. For example, a method of using a tailgate limiter apparatus to adjust the range of motion of a swingout tailgate on a vehicles is provided herein. The method can comprise providing the tailgate limiter apparatus as described above that comprises an elongated body. The elongated body can comprise a first end and a second end and one or more securement apertures that extend through at least a portion of the elongated body to facilitate securement of the elongated body to a tailgate on a vehicle. The elongated body can have a plurality of hinge connector acceptance apertures that extend into the elongated body. The tailgate limiter apparatus can be secured to a swingout tailgate of a vehicle. The method can then include selecting a hinge connector acceptance aperture of the plurality of hinge connector acceptance apertures to which to attach a hinge connector of a hydraulic hinge used on the swingout tailgate of the vehicle. The method can also comprise securing the hinge connector of the hydraulic hinge to a selected hinge connector acceptance aperture of the plurality of hinge connector acceptance apertures to limit the radius of swing of the tailgate of the vehicle to a desired degree of swing based on the position of the respective hinge connector acceptance aperture. Additional steps and substeps are provide as described above and shown with the aid of the figures.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A tailgate limiter apparatus for securement to a tailgate for limiting a range of motion of a swingout tailgate on a vehicle, the tailgate limiter apparatus comprising:
an elongated body comprising:
a first end and a second end;
one or more securement apertures that extend through at least a portion of the elongated body to facilitate securement of the elongated body to a tailgate on a vehicle;
a plurality of hinge connector acceptance apertures that extend through the elongated body, each of the hinge connector acceptance apertures configured to receive a hinge connector of a hydraulic hinge used on the tailgate of the vehicle and the hinge connector acceptance apertures being spaced apart to limit a radius of swing of the tailgate of the vehicle to different degrees of swing based on a position of the respective hinge connector acceptance aperture; and
one or more fasteners configured for insertion into the one or more securement apertures and engaging respective securement holes in the tailgate of the vehicle.

2. The tailgate limiter apparatus according to claim 1, wherein the elongated body further comprises a top surface that extends between the first end and the second end, a bottom surface opposite the top surface that extends between the first end and the second end, a first side that extends between the top surface and the bottom surface and between the first end and the second end, and a second side opposite the first side that extends between the top surface and the bottom surface and the bottom surface and between the first end and the second end.

3. The tailgate limiter apparatus according to claim 2, wherein:
The one or more securement apertures in the elongated body comprises a first end securement aperture that extends through at least a portion of the elongated body proximate to the first end and a second end securement aperture that extends through at least a portion of the elongated body proximate to the second end;
the first end securement aperture is configured for alignment with a mid-door securement hole in a tailgate of a vehicle; and
the second end securement aperture is configured for alignment with a distal end door securement hole in the tailgate of the vehicle.

4. The tailgate limiter apparatus according to claim 3, further comprising:
an elongated bolt having a head on a first end and being threaded on at least a second end, the elongated bolt configured for insertion through the second end securement aperture and engaging the distal end door securement hole in the tailgate of the vehicle; and
a pinch bracket having a bracket aperture for receiving the second end of the elongated body.

5. The tailgate limiter apparatus according to claim 1, wherein the elongated body further comprises a first side that extends between the first end and the second end, and a second side opposite the first side that extends between the first end and the second end.

6. The tailgate limiter apparatus according to claim 5, wherein the plurality of hinge connector acceptance apertures that extend through at least the first side of the elongated body between the first securement aperture and the second securement aperture.

7. A tailgate limiter apparatus for securement to a tailgate for limiting a range of motion of a swingout tailgate on a vehicle, the tailgate limiter comprising:
an elongated body comprising:
a top surface, a bottom surface, a first side that extends between the top surface and the bottom surface, a second side opposite the first side that extends between the top surface and the bottom surface, a first end and a second end;
a first end securement aperture that extends through at least a portion of the elongated body at the first end configured for alignment with a mid-door securement hole in a tailgate of a vehicle;
a second end securement aperture that extends through at least a portion of the elongated body at the second end configured for alignment with a distal end door securement hole in the tailgate of the vehicle; and
a plurality of hinge connector acceptance apertures that extend through at least the bottom surface of the elongated body between the first securement aperture and the second securement aperture, each of the hinge connector acceptance apertures configured to receive a hinge connector of a hydraulic hinge used on the tailgate of the vehicle and the hinge connector acceptance apertures being spaced apart to limit a radius of swing of the tailgate of the vehicle to different degrees of swing based on a position of the respective hinge connector acceptance aperture;
an elongated bolt having a head on a first end and being threaded on at least a second end, the elongated bolt configured for insertion through the second end securement aperture and engaging the distal end door securement hole in the tailgate of the vehicle; and
a pinch bracket having a bracket aperture for receiving the second end of the elongated body.

8. The tailgate limiter apparatus according to claim 7, wherein the elongated body has a slot on the top surface positioned between the second end securement aperture and the plurality of hinge connector acceptance apertures configured for providing space to receive a bolt head extending from the bottom of the tailgate when the elongated body is installed.

9. The tailgate limiter apparatus according to claim 8, wherein the slot in the elongated body extends through the first and second sides of the elongated body.

10. The tailgate limiter apparatus according to claim 9, wherein the slot comprises a floor and opposing walls that extend up from the floor of the slot at an angle extending away from each other.

11. The tailgate limiter apparatus according to claim 8, wherein the elongated body has an accommodation indention on the top surface between the slot and the second end securement aperture, the indention configured to receive an attachment mechanism of the tailgate of the vehicle.

12. The tailgate limiter apparatus according to claim 7, wherein the first end of the elongated body has a securement indention on the bottom surface of the elongated body between the first and second sides that extends through the first end, the first end securement aperture extending through the first end of the elongated body at the securement indention.

13. The tailgate limiter apparatus according to claim 7, wherein the bottom surface of the elongated body comprises a hinge attachment indention that extends a length of a hinge attachment area in which the plurality of hinge connector acceptance apertures resides.

14. The tailgate limiter apparatus according to claim 13, wherein each of the plurality of hinge connector acceptance apertures comprises a counterbore in the bottom surface of the elongated body in the hinge attachment indention.

15. The tailgate limiter apparatus according to claim 13, wherein the hinge attachment indention has a depth of between about 0.0610 inches and about 0.0640 inches.

16. The tailgate limiter apparatus according to claim 7, wherein the second end securement aperture comprises a counterbore in the bottom surface of the elongated body for receiving the head of the elongated bolt.

17. The tailgate limiter apparatus according to claim 7, further comprising a nut configured to be screwed on the threaded second end of the elongated bolt.

18. The tailgate limiter apparatus according to claim 17, wherein the elongated bolt comprises a length that permits the elongated bolt to be inserted through the second end securement aperture into the tailgate of the vehicle and through a structure in the tailgate of the vehicle with threaded second need of the elongated bolt being placed through the pinch bracket such that the pinch bracket resides against the structure in the tailgate and the nut is screwed onto the threaded second end of the elongated bolt to abut the pinch bracket.

19. The tailgate limiter apparatus according to claim 7, wherein hinge connector acceptance apertures of the plurality of hinge connector acceptance apertures are spaced apart along the elongated body such that when secured to the tailgate of the vehicle, the plurality of hinge connector acceptance apertures limit the radius of swing of the tailgate between about 80° and about 135°.

20. The tailgate limiter apparatus according to claim 19, wherein a first hinge connector acceptance aperture of the plurality of hinge connector acceptance apertures sets the radius of swing of the tailgate at 80°.

21. The tailgate limiter apparatus according to claim 20, wherein a second hinge connector acceptance aperture of the plurality of hinge connector acceptance apertures sets the radius of swing of the tailgate at 90°.

22. The tailgate limiter apparatus according to claim 21, wherein a third hinge connector acceptance aperture of the plurality of hinge connector acceptance apertures sets the radius of swing of the tailgate at 100°.

23. The tailgate limiter apparatus according to claim 22, wherein a fourth hinge connector acceptance aperture of the plurality of hinge connector acceptance apertures sets the radius of swing of the tailgate at 110°.

24. The tailgate limiter apparatus according to claim 23, wherein a fifth hinge connector acceptance aperture of the plurality of hinge connector acceptance apertures sets the radius of swing of the tailgate at 120°.

25. The tailgate limiter apparatus according to claim 24, wherein a sixth hinge connector acceptance aperture of the plurality of hinge connector acceptance apertures sets the radius of swing of the tailgate at 135°.

26. A method of using a tailgate limiter apparatus to adjust a range of motion of a swingout tailgate on a vehicles, the method comprises:
providing the tailgate limiter apparatus comprising an elongated body that comprises a first end and a second end and one or more securement apertures that extend through at least a portion of the elongated body to facilitate securement of the elongated body to a tailgate on a vehicle with a plurality of hinge connector acceptance apertures that extend through the elongated body;
securing the tailgate limiter apparatus to a swingout tailgate of a vehicle;
selecting a hinge connector acceptance aperture of the plurality of hinge connector acceptance apertures to which to attach a hinge connector of a hydraulic hinge used on the swingout tailgate of the vehicle; and
securing the hinge connector of the hydraulic hinge to a selected hinge connector acceptance aperture of the plurality of hinge connector acceptance apertures to limit a radius of swing of the tailgate of the vehicle to a desired degree of swing based on a position of a respective hinge connector acceptance aperture.
